(19) United States
(12) Patent Application Publication
(10) Pub. No.: US 2008/0061753 A1
(43) Pub. Date: Mar. 13, 2008

(54) Power factor correction circuit using step down regulator

(75) Inventors: Reinhard Koegel, Brigachtal (DE); Jean-Paul Louvel, Brigachtal-Kirchdorf (DE); Michael Meitzner, VS-Pfaffenweiler (DE)

Correspondence Address: MORGAN LEWIS & BOCKIUS LLP, 1111 PENNSYLVANIA AVENUE NW, WASHINGTON, DC, 20004, US

(73) Assignee: TTE Germany GmbH

(21) Appl. No.: 11/544,641

(22) Filed: Oct. 10, 2006

(30) Foreign Application Priority Data
Sep. 12, 2006 (CN) 200610062547

(51) Int. Cl. G05F 1/00

(52) U.S. Cl. 323/282

(57) ABSTRACT

A PFC circuit using a step down regulator includes an input port receiving input AC mains voltage, an output port providing an output DC mains voltage, a mains rectifier connected to the input port, a step down circuit connected to the mains rectifier for providing the output DC mains voltage to the output port, a switch connected to the step down circuit, a current source circuit generating a current signal corresponding to a level of the output DC mains voltage, a current sense resistor connected to the switch to provide a voltage signal corresponding to a level of a current flowing through the switch, and a PFC control unit receiving the current signal and the voltage signal and controlling the switch in accordance therewith to selectively enable and disable the step down circuit. The PFC circuit according to the present invention reduces the supply voltage of the SMPS and thus reduces the size of the SMT device and the cost for making such SMT device.

### BACKGROUND OF THE INVENTION

1. Field of the Invention

The present invention relates to a circuit for generating a low mains voltage (DC) with full power factor correction (PFC) function.

2. Discussion of the Related Art

In the related art, the PFC function typically creates a DC output voltage of about 400V DC. This output voltage from the PFC circuit serves as the input voltage of a switch mode power supply (SMPS), which follows the PFC circuit. Surface mount technology (SMT) is a technology for constructing electronic circuits where the components are mounted directly onto the surface of the printed circuit boards (PCBs). When SMT components of SMPS are supplied with a high DC voltage, the maximum voltage across the primary and secondary pins is consequently high. Therefore, SMT components with large sizes must be used to separate the components with large distances due to the high voltages between the primary and the secondary pins of the SMT chips.

Alternatively, in order to maintain short distances between the primary and the secondary pins, a low DC voltage is necessary to meet the requirements of the standard EN60065 when using SMT. The,standard EN60065 determines the clearance and creepage distances according to the maximum voltage between pins, which is measured directly at the SMT components between the primary and secondary pins. Therefore, in order to minimize the clearance and creepage distances at the SMT components, a low DC voltage is required as an input voltage to the SMPS. When the input voltage of the SMPS is low, it is easier to meet the requirements of the standard EN60065 for the clearance and creepage distances. Therefore, it is possible to use cheaper transformer technologies. Furthermore, additional cost benefits can be obtained since it is possible to make smaller devices due to short distances between the primary and the secondary pins.

FIG. 1 is a schematic step down regulator circuit using a PFC control unit according to the related art. The circuit illustrated in FIG. 1 includes a mains rectifier 5 having four diodes 1, 2, 3, and 4, a switch 6, a diode 7, an inductor 8, a capacitor 9, and a PFC control unit 10. The PFC control unit 10 is used to control the step down regulator circuit 20. The input and output voltages of this step down regulator circuit 20 are shown in FIG. 2. In FIG. 2, the AC input voltage is rectified to a DC voltage in the PFC working area. The temporal operation of the PFC corresponds to the cross-hatched region. There is another area between the adjacent PFC working areas, where the output voltage starts to decay from the DC voltage that was fixed in the PFC working area. As shown in FIG. 2, the DC voltage in the PFC working area is higher than the peak value of the mains input voltage. In fact, the DC voltage is relatively high (typically 400V) and therefore it is very difficult to meet the requirements of the standard EN60065. This output voltage from the PFC step down regulator is fed into the SMPS, and therefore the input voltage of the SMPS is very high. This leads to a high peak voltage level between the primary pin and the secondary pin of the SMT components in the SMPS.

### SUMMARY OF THE INVENTION

Accordingly, the present invention is directed to a PFC circuit using a step down regulator that substantially obviates one or more of the problems due to limitations and disadvantages of the related art.

An object of the present invention is to reduce the supply voltage of the SMPS by using a PFC circuit in order to reduce the size of the SMT device and the cost for making such SMT device. Another object of the present invention is to reduce the voltage stress for the power switches such as transistors and to smooth capacitors. Another object of the present invention is to provide a circuit having a higher electromagnetic compatibility. Yet, another object of the present invention is to reduce the cost of smoothing the capacitors and most of the other components in the circuit.

Additional features and advantages of the invention will be set forth in part in the description that follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the present invention, as embodied and broadly described, the PFC circuit using step down regulator includes an input port receiving input AC mains voltage, an output port providing an output DC mains voltage, a mains rectifier connected to the input port, a step down circuit connected to the mains rectifier for providing the output DC mains voltage to the output port, a switch connected to the step down circuit, a current source circuit generating a current signal corresponding to a level of the output DC mains voltage, a current sense resistor connected to the switch to provide a voltage signal corresponding to a level of a current flowing through the switch, and a PFC control unit receiving the current signal and the voltage signal and controlling the switch in accordance therewith to selectively enable and disable the step down circuit.

In another aspect, the present invention includes a switch mode power supply (SMPS) using a PFC circuit having an input port of a PFC circuit receiving input AC mains voltage, an output port of a PFC circuit providing an output DC mains voltage, a mains rectifier connected to the input port, a step down circuit connected to the mains rectifier for providing the output DC mains voltage to the output port, a switch connected to the step down circuit, a current source circuit generating a current signal corresponding to a level of the output DC mains voltage, a current sense resistor connected to the switch to provide a voltage signal corresponding to a level of a current flowing through the switch, and a PFC control unit receiving the current signal and the voltage signal and controlling the switch in accordance therewith to selectively enable and disable the step down circuit, wherein the output DC mains voltage of the PFC circuit is the input voltage of the SMPS.

In yet another aspect, a method of generating a low DC mains voltage includes the steps of receiving an input AC mains voltage from an input port, generating a rectified signal from the input AC mains voltage, generating a step down voltage from the rectified signal to provide an output DC mains voltage to an output port, generating a current signal from the step down voltage corresponding to a level of a output DC mains voltage, generating a voltage signal corresponding to a level of a current flowing through a switch, and controlling the switch to selectively enable and disable the generation of the step down voltage in accordance with the current signal and the voltage signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a portion of this specification, illustrate embodiments of the invention and together with the description serve to explain the principles of the invention. In the drawings:

FIG. 1 is a schematic step down regulator circuit using a PFC control unit according to the related art;

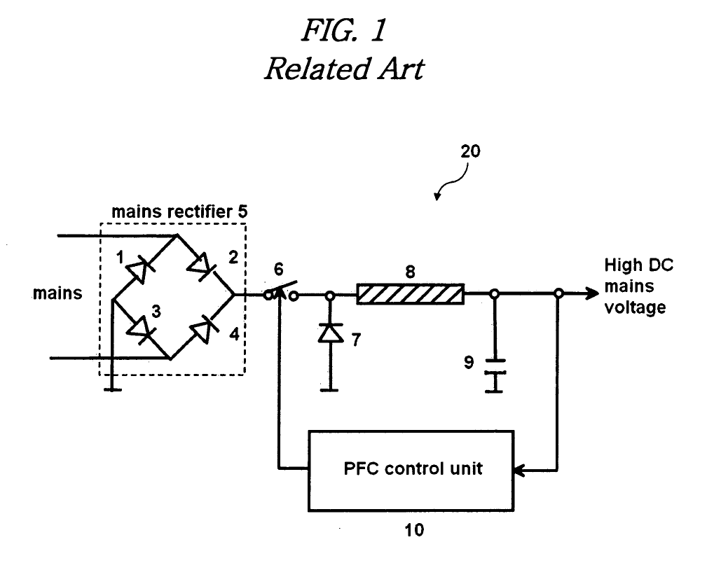

FIG. 2 illustrates input and output voltages of the step down circuit according to the related art;

FIG. 3 is a schematic step down regulator circuit using a PFC control unit according to an exemplary embodiment of the inventive circuit; and

FIG. 4 illustrates exemplary input and output voltages of the step down regulator circuit according to the exemplary embodiment of the inventive circuit.

### DETAILED DESCRIPTION OF THE PREFERRED EMBODIMENTS

Reference will now be made in detail to the preferred embodiments of the present invention, examples of which are illustrated in the accompanying drawings.

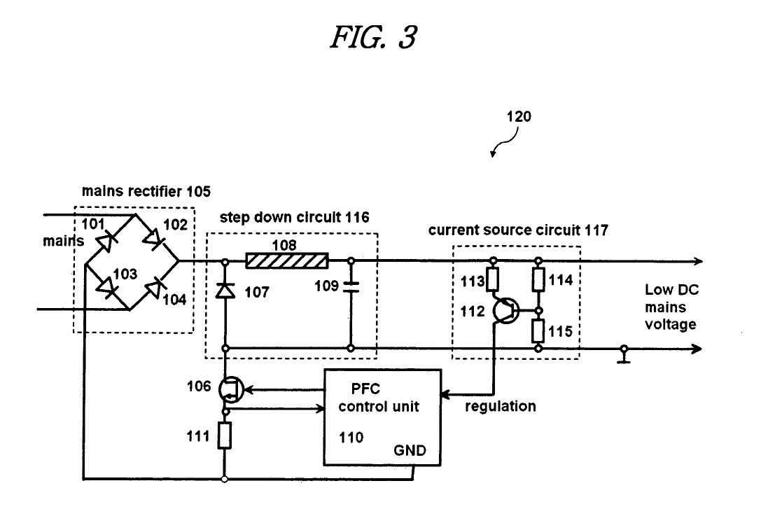

An exemplary embodiment of the step down regulator circuit is shown in FIG. 3. The circuit illustrated in FIG. 3 includes a mains rectifier 105 having four diodes 101, 102, 103, and 104, a switch 106, a current sensing resistor 111, a step down circuit 116 having a diode 107, an inductor 108, and a capacitor 109, and a current source circuit 117 having a transistor 112, and three resistors 113, 114, and 115. The switch 106 and transistor 112 may each be either a bipolar transistor or a MOSFET transistor. In this example, the switch 106 is a MOSFET and transistor 112 is a bipolar transistor.

In the circuit, a first terminal of the inductor 108 is connected to the cathode of the diode 107, and a second terminal of the inductor 108 is connected to a first terminal of the capacitor 109. A second terminal of the capacitor 109 and the anode of the diode 107 are both connected to the drain of the switch 106. The cathode of the diode 107 is also connected to a terminal of the mains rectifier 105. The ground GND of the PFC control unit 110 is connected directly to another terminal of the mains rectifier 105. A first terminal of the current sensing resistor 111 is connected to the source of the switch 106 and a second terminal of the resistor 111 is connected to ground GND. The gate of the switch 106 is connected to a terminal of the PFC control unit 110, and the source of the switch 106 is connected to another terminal of the PFC control unit 110. The collector of the transistor 112 in the current source circuit is connected to yet another terminal of the PFC control unit 110. A first terminal of the resistor 113 is connected to the emitter of the transistor 112. A second terminal of the resistor 113 is connected to a first terminal of the resistor 114. A second terminal of the resistor 114 is connected to the base of the transistor 112 and a first terminal of the resistor 115. A second terminal of the resistor 115 is connected to ground GND. The voltage between the first terminal of the resistor 114 and the second terminal of the resistor 115 generates the output DC mains voltage.

One of the differences of the exemplary embodiment compared to circuits in the related art is that the switch 106 is not inserted in line to the input voltage. In the related art, the switch 6 was inserted in line to the input voltage and due to the voltage potential of the switch 6 it was difficult for the PFC control unit 10 to drive the switch 6. In the exemplary embodiment according to the present invention, the switch 106 is inserted in the ground line to the mains rectifier 105.

Furthermore, the voltage at the input terminal of a current sensing resistor 111 connected to the switch 106 is provided to the PFC control unit 110, which determines the current flowing through the resistor 111 when the switch 106 is closed (switched ON). In other words, the current sensing resistor 111 enables the PFC control unit 110 to determine the current flowing through the switch 106.

As previously mentioned, the current source circuit 117, which includes resistors 113, 114, and 115 and the transistor 112, is connected to the output voltage port. The current source circuit 117 converts the voltage level of the output port into a corresponding current signal. In other words, the level of the DC mains output voltage is converted into a corresponding current signal in the current source circuit 117 and then provided to the PFC control unit 110. This current signal, which is proportional to the output voltage, is used at the PFC control unit 110 to control the operation of the switch 106, i.e., opening and closing of the switch 106, so that the output voltage is regulated.

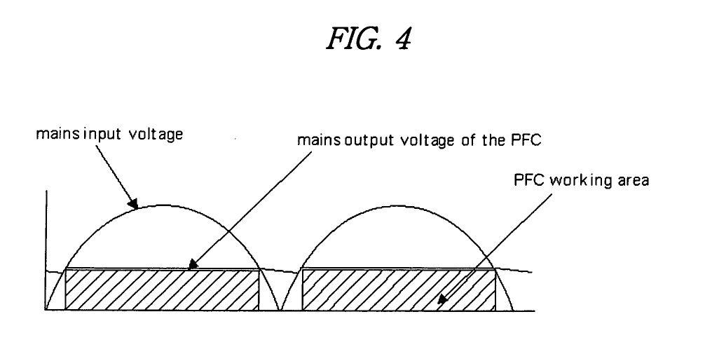

Exemplary input and output voltages according to the step down regulator circuit 120 in the present invention are shown in FIG. 4. During a phase when the input voltage is higher than the output voltage, the switch 106 is closed and the step down regulator circuit 120 starts to operate. As a result, the output voltage of the step down regulator 120 becomes a DC voltage in this phase, which is shown as a cross-hatched region in FIG. 4. On the other hand, during a phase when the input voltage becomes lower than the output voltage, the switch 106 is opened and, therefore, the step down regulator circuit 120 is turned off. In this phase, the output voltage of the step down regulator 120 is no longer maintained to be a constant DC voltage since the step down regulator circuit 120 is turned off. As a result, the output voltage starts to decay until the input voltage becomes higher than the output voltage again, which leads back to the phase when the step down regulator circuit 120 again operates. This completes one cycle of the operation of the step down regulator circuit 120.

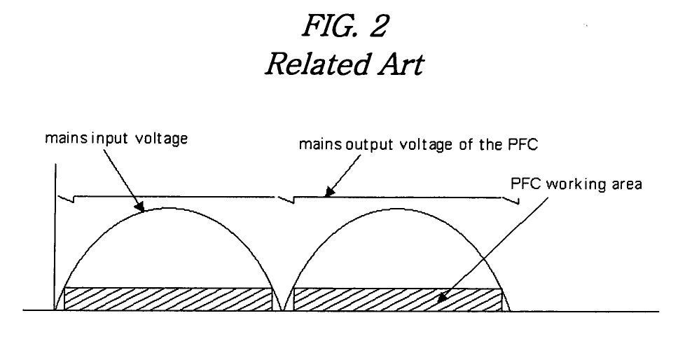

As shown in FIG. 4, the PFC control unit 110 controls the mains output voltage to be significantly lower than the mains output voltage in the related art (FIG. 2), and always lower than the peak mains input voltage. Thus, the SMT components can be supplied with a low DC voltage, for example, a voltage that is less than 200V. Therefore, it is possible to use cheaper transformer technologies and also possible to create smaller SMT devices since the distance between the primary and the secondary pins can be shorter.

However, as shown in FIGS. 2 and 4, there is a tradeoff between the level of the DC output voltage and the voltage ripple of the output capacitor. As the output voltage gets higher, the voltage ripple of the output capacitor becomes lower. Therefore, the time that the step down circuit 116 is disabled is slightly longer in the present invention compared to a PFC circuit of the related art. This slightly reduces the power factor. Also the output voltage ripple in the present invention is higher than the voltage ripple of a PFC circuit of the prior art. Nevertheless, the level of the DC output voltage in the present invention is significantly lower than the DC output voltage in the related art. Furthermore, the output voltage ripple in the present invention is still acceptable.

Also, there are additional advantages in the step down regulator circuit according to the present invention. In particular, the PFC circuit can be used in countries with a large range of input AC mains voltages (from about 400V to less than 200V). As an example, the PFC circuit according to the present invention can provide a quasi regulated voltage around 125V DC for a wide range of input voltage levels. When low input AC mains voltage is detected in a country with low mains voltage, i.e., 110V in the Unites States, the PFC control unit can be disabled unlike step down regulator circuits according to the related art. Disabling the PFC control unit when the mains voltage is low allows better efficiency since there is no switching loss. In the presence of a high input AC mains voltage (310V-400V), an additional PFC or a doubler circuit must be inserted to obtain a low mains voltage needed for the SMPS when using a step down circuit according to the related art. On the other hand, with a PFC circuit according to the present invention, the rectified mains voltage can be directly used as the DC input voltage for the SMPS. Therefore, according to the present invention, it is possible to design a product for worldwide use without the need to insert unnecessary PFC circuits or doubler components.

Furthermore, since the PFC circuit according to the present invention can generate a low DC voltage, it is much easier to meet the requirements of the standard EN60065 for the creepage distance and thus it is possible to use cheaper transformer technologies. Therefore, a lower DC voltage is a strong advantage for the cost of the components.

It will be apparent to those skilled in the art that various modifications and variations can be made in the power factor correction circuit using step down regulator of the present invention without departing from the sprit or scope of the invention. Thus, it is intended that the present invention covers the modifications and variations of this invention provided they come within the scope of the appended claims and their equivalents.

What is claimed is:

1. A power factor correction (PFC) circuit, comprising:
an input port receiving an input AC mains voltage;
an output port providing an output DC mains voltage;
a mains rectifier connected to the input port;
a step down circuit connected to the mains rectifier for providing the output DC mains voltage to the output port;
a switch connected to the step down circuit;
a current source circuit generating a current signal corresponding to a level of the output DC mains voltage;
a current sense resistor connected to the switch to provide a voltage signal corresponding to a level of a current flowing through the switch; and
a PFC control unit receiving the current signal and the voltage signal and controlling the switch in accordance therewith to selectively enable and disable the step down circuit based upon a relationship between the input AC mains voltage and the output DC mains voltage.

2. A PFC circuit according to claim 1, wherein the step down circuit includes a diode, inductor and a capacitor.

3. A PFC circuit according to claim 1, wherein the switch is a first transistor.

4. A PFC circuit according to claim 1, wherein the current source circuit includes a second transistor, and three resistors.

5. A PFC circuit according to claim 1, wherein the PFC control unit uses the voltage signal corresponding to the level of the current flowing through the switch to control the switch to maintain the output DC mains voltage of the step down circuit lower than the effective voltage of the input AC mains voltage.

6. A PFC circuit according to claim 1, wherein the PFC control unit uses the current signal corresponding to a level of the output DC mains voltage to control the switch to maintain the output voltage of the step down circuit lower than the effective voltage of the input AC mains voltage.

7. A PFC circuit according to claim 1, wherein the PFC control unit disables the step down circuit when the output DC mains voltage is higher than the input AC mains voltage.

8. A switch mode power supply (SMPS) using a PFC circuit, comprising:
an input port of a PFC circuit receiving an input AC mains voltage;
an output port of a PFC circuit providing an output DC mains voltage;
a mains rectifier connected to the input port;
a step down circuit connected to the mains rectifier for providing the output DC mains voltage to the output port;
a switch connected to the step down circuit;
a current source circuit generating a current signal corresponding to a level of the output DC mains voltage;
a current sense resistor connected to the switch to provide a voltage signal corresponding to a level of a current flowing through the switch; and
a PFC control unit receiving the current signal and the voltage signal and controlling the switch in accordance therewith to selectively enable and disable the step down circuit based upon a relationship between the input AC mains voltage and the output DC mains voltage;
wherein the output DC mains voltage of the PFC circuit is the input voltage of the SMPS.

9. An SMPS circuit according to claim 8, wherein the step down circuit includes a diode, inductor and a capacitor.

10. An SMPS circuit according to claim 8, wherein the switch is a first transistor.

11. An SMPS circuit according to claim 8, wherein the current source circuit includes a second transistor, and three resistors.

12. An SMPS circuit according to claim 8, wherein the PFC control unit uses the voltage signal corresponding to the level of the current flowing through the switch to control the switch to maintain the output DC mains voltage of the step down circuit lower than the effective voltage of the input AC mains voltage.

13. An SMPS circuit according to claim 8, wherein the PFC control unit uses the current signal corresponding to a level of the output DC mains voltage to control the switch to maintain the output voltage of the step down circuit lower than the effective voltage of the input AC mains voltage.

14. An SMPS circuit according to claim 8, wherein the PFC control unit disables the step down circuit when the output DC mains voltage is higher than the input AC mains voltage.

15. A method of generating a low DC mains voltage, comprising the steps of:
receiving an input AC mains voltage from an input port;
generating a rectified signal from the input AC mains voltage;
generating a step down voltage from the rectified signal to provide an output DC mains voltage to an output port;
generating a current signal from the step down voltage corresponding to a level of a output DC mains voltage;
generating a voltage signal corresponding to a level of a current flowing through a switch receiving the step down voltage; and
controlling the switch to selectively enable and disable the generation of the step down voltage in accordance with the current signal and the voltage signal.

16. The method according to claim 15, further comprising the step of maintaining the output DC mains voltage lower than the effective voltage of the input AC mains voltage.

17. The method according to claim 15, further comprising the step of disabling the generation of the step down voltage when the output DC mains voltage is higher than the input AC mains voltage.
